(19) United States
(12) Patent Application Publication
(10) Pub. No.: US 2014/0369093 A1
(43) Pub. Date: Dec. 18, 2014

(54) ADAPTIVE RCD SNUBBER AND METHOD FOR SWITCHING CONVERTER

(71) Applicant: ABB Research Ltd, Zurich (CH)

(72) Inventors: Ki-Bum PARK, Fislisbach (CH); Francisco CANALES, Baden-Dattwil (CH); Sami PETTERSSON, Wettingen (CH)

(73) Assignee: ABB RESEARCH LTD,, Zurich (CH)

(21) Appl. No.: 14/306,807

(22) Filed: Jun. 17, 2014

(30) Foreign Application Priority Data
Jun. 17, 2013 (EP) 13172258.9

(51) Int. Cl. H02M 1/34

(52) U.S. Cl. CPC H02M 1/34; H02M 2001/348
USPC 363/50

(57) ABSTRACT

Exemplary embodiments provide a method and an adaptive RCD snubber circuit for a switching converter having a series-connection of a main inductor and a main switching device. A voltage stress of the main switching device is sensed, and the sensed voltage stress is controlled to a reference level by controlling a snubber capacitor voltage, wherein the snubber capacitor voltage is controlled by adjusting the snubber resistance of the RCD snubber.

### RELATED APPLICATION(S)

This application claims priority under 35 U.S.C. §119 to European application no. 13172258.9 filed in Europe on Jun. 17, 2013, the entire content of which is hereby incorporated by reference.

### FIELD

The present disclosure relates to voltage stress suppression of semiconductor switches and particularly to RCD snubbers.

### BACKGROUND INFORMATION

In order to guarantee a voltage stress margin of semiconductors, voltage snubbers can be used to suppress additional voltage stress induced by an inductive component, for example. An RCD snubber is a widely used snubber topology for suppressing the additional voltage stress due to its simple structure and high reliability. The basic operation of the RCD snubber relies on storing energy from the power converter into a capacitor and dissipating the energy through a resistor.

FIG. 1 illustrates an example of a known RCD snubber 11 in a fly-back converter, as described in H. —S. Choi, “AN4137 - Design guidelines for off-line flyback converters using Fairchild Power Switch (FPS)”, Fairchild Semiconductor Cor., 2003. In FIG. 1, the main transformer 12 is represented as an equivalent circuit having an ideal transformer coupled with a magnetizing inductance Lₘ and a leakage inductance L_{lkg}. The primary side of the transformer 12 is connected in series with the main switching device Q. The series-connection is supplied by a voltage supply V. On the secondary side of the transformer 12, an output capacitor Cₒ is coupled with the secondary winding through an output diode Dₒ. A load connected to the flyback converter is represented by a resistance Rₒ. The known RCD snubber 11 in FIG. 1 consists of a snubber diode Dₛₙ, a snubber capacitor Cₛₙ, and a snubber resistor Rₛₙ.

FIGS. 2a and 2b illustrate exemplary waveforms of some voltages and currents of the switching converter of FIG. 1. FIG. 2a shows a current I_{Lm} through the magnetizing inductance Lₘ and a current I_{lkg} through the leakage inductance L_{lkg}. FIG. 2b shows a voltage v_{Csn} over the snubber capacitor Cₛₙ, a voltage v_{Q} over the switch Q, and the supply voltage Vₛ. At instant t₁, the switch Q is turned off and the voltage stress over the switch starts to rise. The leakage inductance increases the voltage stress. Therefore, the RCD snubber is used for clamping a voltage over the switch to a tolerable level. FIG. 2b shows the voltage v_{Q} over the switch Q being clamped at approximately 1350 V.

The RCD snubber can be designed on the basis of the worst-case operating conditions, e.g., operating conditions causing the highest voltage stress on the semiconductor, and the tolerance of the parameters. Thus, the RCD snubber can cause large power losses even during normal operating conditions. If the normal operating conditions are very different than the worst-case operating conditions, the snubber power losses can be much higher than those of an RCD snubber optimized for normal operating conditions.

### SUMMARY

An exemplary adaptive RCD snubber circuit for a switching converter having a series-connection of a main inductor and a main switching device, the snubber circuit comprising: a snubber capacitor and a snubber diode; a controllable snubber resistance; means for sensing a voltage stress of the main switching device; and a snubber capacitor voltage controller configured to control the sensed voltage stress to a reference level by controlling a snubber capacitor voltage, the snubber capacitor voltage being controlled by adjusting the controllable snubber resistance.

An exemplary method for a switching converter having a series-connection of a main inductor and a main switching device and a RCD snubber circuit, the method comprising: sensing a voltage stress of the main switching device, and controlling the sensed voltage stress to a reference level by controlling a snubber capacitor voltage, wherein the snubber capacitor voltage is controlled by adjusting the snubber resistance of the RCD snubber.

### DESCRIPTION OF THE DRAWINGS

In the following the disclosure will be described in greater detail by means of preferred embodiments with reference to the attached drawings, in which

FIG. 1 illustrates an example of an RCD snubber in a fly-back converter in accordance with a known implementation;

FIGS. 2a and 2b illustrate exemplary waveforms of voltages and currents of the known switching converter of FIG. 1;

FIG. 3 illustrates a conceptual diagram of an adaptive RCD (ARCD) snubber circuit in accordance with an exemplary embodiment of the present disclosure;

FIG. 4 illustrates an example of the ARCD snubber concept in a flyback converter in accordance with an exemplary embodiment of the present disclosure;

FIG. 5 illustrates an exemplary embodiment of the ARCD snubber in a flyback-type switching converter in accordance with an exemplary embodiment of the present disclosure;

FIGS. 6a to 6c show exemplary simulation waveforms for the known RCD snubber of FIG. 1 at an input voltage of 1200 V;

FIGS. 7a to 7c show exemplary simulation waveforms for the known RCD snubber of FIG. 1 at an input voltage of 1000 V;

FIGS. 8a to 8c show exemplary simulation waveforms for an ARCD snubber at an input voltage of 1200 V in accordance with an exemplary embodiment of the present disclosure; and

FIGS. 9a to 9c show exemplary simulation waveforms for an ARCD snubber at an input voltage of 1000 V in accordance with an exemplary embodiment of the present disclosure.

### DETAILED DESCRIPTION

Exemplary embodiments of the present disclosure provide a method and an apparatus for implementing the method to alleviate the above disadvantages.

The exemplary embodiments described herein provide an adaptive RCD (ARCD) snubber topology for a switching converter. In order to reduce the power loss and limit the voltage stress effectively, an ARCD snubber includes a snubber resistance which can be adjusted on the basis of the operation point. For example, the snubber resistance can be formed a series connection of a resistor and a transistor controlling the current through the resistor. The transistor can be controlled on the basis of the voltage stress.

The exemplary ARCD snubber topology described herein can provide some advantages over a known RCD snubber. In the ARCD topology according to exemplary embodiments of the present disclosure, maximum switch voltage stress can effectively be limited by the control. This can lead to higher reliability. Because the maximum switch voltage stress can be limited effectively, an increased duty ratio of the switching converter can be used, which can result in further reduction in conduction losses. Further, as the snubber resistance is actively controlled, reduced snubber losses can be achieved at nominal operating conditions.

The disclosed ARCD snubber topology can be applied to various types of converter topologies and can easily be adapted with a few additional components augmented from a known RCD snubber.

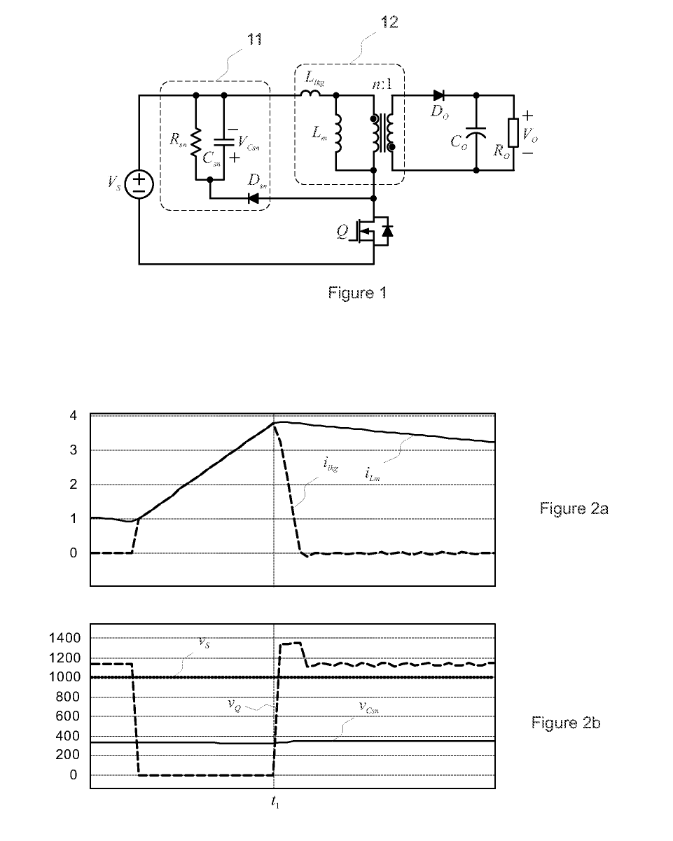

In order to achieve a stable snubber capacitor voltage, the average power dissipated in the snubber capacitor should correspond with the average power flowing through the leakage inductance L_{lkg} in FIG. 1. Thus, the dissipated power Pₛₙ of the known RCD snubber in FIG. 1 can be calculated as follows:

$${P}_{sn} = \frac{{V}_{Csn}^{2}}{{R}_{sn}} = \frac{1}{2} {F}_{s} {L}_{lkg} {I}_{Q , peak}^{2} \frac{{V}_{Csn}}{{V}_{Csn} - {nV}_{o}} , \qquad ( 1 )$$

where V_{Csn} is the voltage over the snubber capacitor Cₛₙ; Fₛ is the switching frequency of the switching converter; I_{Q,peak} is the peak value of the current through the switching device Q; n is the turns ratio of the transformer T; Vₒ is the output voltage of the switching converter.

Equation 1 shows that if the snubber resistance Rₛₙ is reduced, the power loss Pₛₙ increases. At the same time, the voltage v_{Csn} over the snubber capacitor inversely proportional to the power loss Pₛₙ, e.g., when the power loss Pₛₙ increases, the voltage stress decreases. Thus, both the power loss in the snubber and the voltage stress on the switch can have to be considered when selecting the snubber resistance Rₛₙ. The capacitance of Cₛₙ can be determined by considering the voltage ripple ΔV_{Csn}:

$$Δ {V}_{Csn} = \frac{{V}_{Csn}}{{C}_{sn} {R}_{sn} {F}_{s}} \qquad ( 2 )$$

In some cases, such as in a case of a 3-phase auxiliary power supply (APS) application where the input voltage can reach up to 1200 V, the switch voltage stress margin can be narrow because of availability of suitable semiconductors as described in S. Buonomo et al., “AN1889—STC03DE170 in 3-phase auxiliary power supply,” STMicroelectronics, 2003. In other words, the known RCD snubber of FIG. 1 can be able to limit the additional voltage stress to a very low level. A smaller additional voltage stress causes higher snubber losses as presented in Equation 1. Consequently, the power loss in the snubber is inevitably large in the worst-case conditions. However, power loss can be high even at the nominal input voltage.

In order to reduce the power loss under normal operating conditions while still effectively limiting the voltage stress under the worst-case operating conditions, exemplary embodiments of the present disclosure provide an adaptive RCD (ARCD) snubber topology, in which the resistance of the RCD snubber is adjusted on the basis of the operation point.

The exemplary ARCD snubber topology of the present disclosure can be applied to a switching converter including a series-connection of a main inductor and a main switching device and a RCD snubber circuit, for example. A voltage stress of the main switching device can be sensed, and the snubber resistance can be controlled on the basis of the sensed voltage stress. For example, the sensed voltage stress can be limited to a reference level by controlling the snubber capacitor voltage, where the snubber capacitor voltage can be controlled by adjusting the snubber resistance of the RCD snubber. The voltage stress can be represented by a sum of a voltage over the snubber capacitor and a voltage over the series-connection of the main inductor and the main switching device, for example.

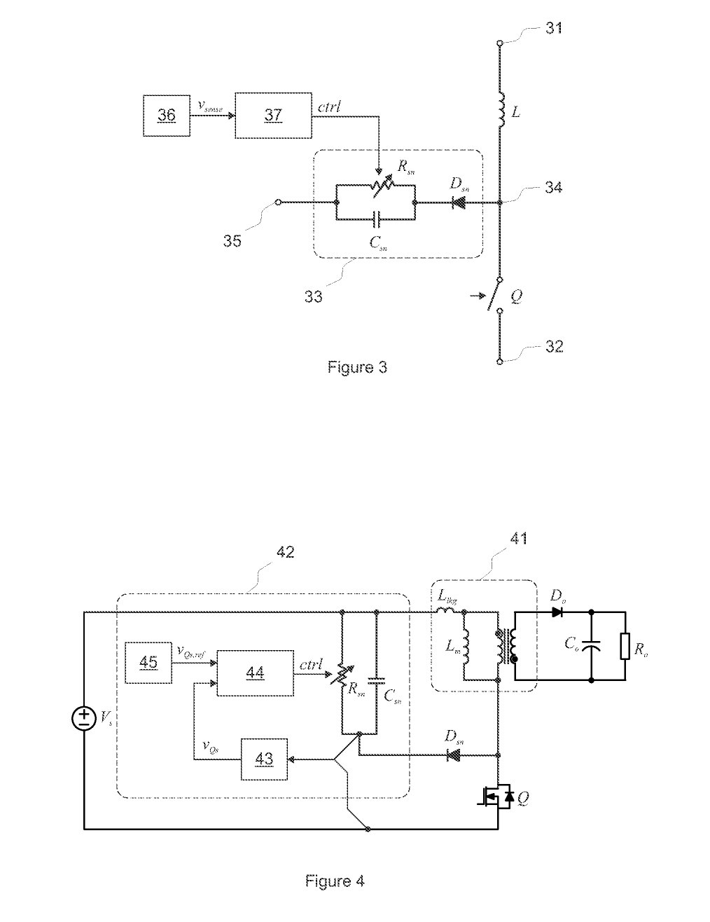

FIG. 3 illustrates a conceptual diagram of an adaptive RCD snubber circuit in accordance with an exemplary embodiment of the present disclosure. In FIG. 3, a main inductor L and a main switching device Q are connected in series between nodes 31 and 32 which can be supplied by an input supply voltage, for example. The adaptive RCD snubber 33 is connected from one end to a node 34 between the main inductor L and the main switching device Q. The other end 35 of the adaptive RCD snubber 33 can be connected to the potential of either end of the series connection of the main inductor L and the main switching device Q, e.g., to the potential of node 31 or node 32, for example.

The adaptive RCD snubber circuit 33 includes a snubber capacitor Cₛₙ, a snubber diode Dₛₙ, and a controllable snubber resistance Rₛₙ. The adaptive RCD snubber further includes means 36 for sensing the voltage stress Vₛₑₙₛₑ of the target component, e.g., the switching device Q in FIG. 3, and a controller 37 controlling the snubber resistance Rₛₙ to minimize the power loss and/or limit the maximum voltage stress of the target component. The controller 37 can be a voltage controller configured to control the sensed voltage stress to a reference level by controlling a snubber capacitor voltage v_{Csn}. The snubber capacitor voltage v_{Csn} can be controlled by adjusting the controllable snubber resistance Rₛₙ.

The exemplary ARCD snubber topology is applicable to various switching converter topologies. FIG. 4 illustrates an example of the ARCD snubber concept in a flyback converter in accordance with an exemplary embodiment of the present disclosure. The flyback converter includes a series-connection of a main inductor and a main switching device Q. The main inductor is in the form of the primary side of a main transformer 41. The main transformer 41 is represented as an equivalent circuit including an ideal transformer coupled with a magnetizing inductance Lₘ and a leakage inductance L_{lkg}. The series-connection of the transformer 41 primary side and the main switching device Q is supplied by a voltage supply Vₛ. On the secondary side of the transformer 41 in FIG. 4, an output capacitor Cₒ is coupled with the secondary winding through an output diode Dₒ. A load connected to the flyback converter is represented by a resistance Rₒ.

An adaptive RCD (ARCD) snubber circuit 42 is connected parallel to the transformer 41 primary side in FIG. 4. The ARCD snubber circuit 42 includes a snubber capacitor Cₛₙ, a snubber diode Dₛₙ, and a controllable snubber resistance Rₛₙ.

The ARCD snubber 42 further includes means 43 for sensing the voltage stress v_{Qs} of the switching device Q. The voltage stress of a target component can be represented by a sum of a voltage over the series-connection and a voltage over the snubber capacitor, for example. In FIG. 4, the sensed voltage stress is measured as a voltage over a path formed by the main switching device and the snubber diode.

A controller 44 in the ARCD snubber 42 controls the snubber resistance Rₛₙ in order to minimize the power losses and clamp the maximum voltage stress of the switching device Q. The controller 44 in FIG. 4 is a snubber capacitor voltage controller configured to control the sensed voltage stress to a reference level v_{Qs,ref} by controlling the snubber capacitor voltage v_{Csn}. In FIG. 4, the reference level v_{Qs,ref} represents a maximum allowable switch voltage and is supplied by a reference generator 45. The snubber capacitor voltage v_{Csn} is controlled by adjusting the controllable snubber resistance Rₛₙ.

Under normal operating conditions, the controllable snubber resistance Rₛₙ is set to the default resistance in order to minimize the power losses. The ARCD snubber senses the switch voltage stress. The ARCD snubber compares voltage stress v_{Qs} with the given reference v_{Qs,ref}. If the switch voltage stress reaches the reference level v_{Qs,ref}, the ARCD snubber controls controllable snubber resistance Rₛₙ to limit the switch voltage stress within v_{Qs,ref}. In FIG. 4, the sensed voltage stress is measured as a voltage v_{Qs} over a path formed by the main switching device Q and the snubber diode Dₛₙ, e.g., the sum of the supply voltage Vₛ and the snubber capacitor voltage v_{Csn}.

The controllable snubber resistance and the snubber voltage controller can be implemented in various ways.

FIG. 5 illustrates an exemplary embodiment of the ARCD snubber in a flyback-type switching converter in accordance with an exemplary embodiment of the present disclosure. In FIG. 5, the flyback converter includes a series-connection of the primary side of a transformer 51 and a main switching device Q. The transformer 51 is represented as an equivalent circuit including an ideal transformer coupled with a magnetizing inductance Lₘ and a leakage inductance L_{lkg}. The series-connection the primary side and the main switching device Q is supplied by a voltage supply Vₛ. On the secondary side of the transformer 51 in FIG. 5, an output capacitor Cₒ is coupled with the secondary winding through an output diode Dₒ. A load connected to the flyback converter is represented by a resistance Rₒ.

In FIG. 5, an adaptive RCD snubber circuit is connected parallel to the primary side of the transformer 51. The adaptive RCD snubber includes a snubber capacitor Cₛₙ, a snubber diode Dₛₙ, and a controllable snubber resistance 52. The controllable snubber resistance 52 includes a series connection of a snubber transistor Qₛₙ and a first snubber resistor R_{sn,1}. The series connection is connected in parallel with a second snubber resistor R_{sn,2}. In FIG. 5, the transistor Qₛₙ is a MOSFET.

The adaptive RCD snubber in FIG. 5 further includes means 53 for sensing the voltage stress v_{Qs} of the switching device Q. A voltage divider formed by resistors R_{Qs,1} and R_{Qs,2} is used to measure the voltage stress v_{Qs} as a voltage over the main switching device Q and the snubber diode Dₛₙ. The voltage stress v_{Qs} is filtered by a low-pass filter formed by a capacitor C_{Qs} and the voltage divider.

A controller 54 in FIG. 5 controls the snubber resistance Rₛₙ in order to clamp the maximum voltage stress of the switching device Q to a tolerable level. The controller 54 in FIG. 5 is an integrating controller configured to control the sensed voltage stress to a reference level v_{Qs,ref} by controlling the snubber capacitor voltage v_{Csn}. The integrating controller is formed by an operational amplifier U_{ctl}, a capacitor C_{ctl} and a resistor R_{ctl}.

In FIG. 5, the controller 54 controls the snubber capacitor voltage v_{Csn} by adjusting the controllable snubber resistance 52. The snubber transistor Qₛₙ is configured to control current through the controllable snubber resistance 52 responsive to a control signal v_{ctl} from the snubber capacitor voltage controller 54. The snubber transistor Qₛₙ can operate in an active region for linear regulation.

The reference level v_{Qs,ref} represents a maximum allowable switch voltage. The reference level v_{Qs,ref} can be generated by a reference voltage circuit as illustrated in FIG. 5, for example. The reference voltage circuit 55 in FIG. 5 includes a series-connection of a resistor R_{Qs,ref} and a zener-diode D_{Qs,ref}.

The controller 54 compares the sensed voltage stress v_{Qs} with the given reference v_{Qs,ref}. Under normal operating conditions, the sensed voltage stress v_{Qs} is below the reference level v_{Qs,ref} and the controller 54 controls the snubber transistor to a non-conducting state. Thus, current flows through only the second snubber resistor R_{sn,2}.

However, if the switch voltage stress v_{Qs} reaches the reference level v_{Qs,ref}, the controller 54 starts to control current through the controllable snubber resistance 52 by controlling the flow of current through the snubber transistor Qₛₙ. At the same time, the snubber diode Dₛₙ clamps the voltage over main switching device Q to the sum of the supply voltage Vₛ and the snubber capacitor voltage v_{Csn}. Thus, the sum Vₛ+V_{Csn} effectively determines the maximum voltage stress of the main switching device Q. By controlling the current through the controllable snubber resistance 52, the controller 54 is able to control the snubber capacitor voltage v_{Csn}, and therefore, the voltage stress over main switching device Q.

In the disclosed ARCD snubber topology, the second snubber resistor R_{sn,2} can be dimensioned for the normal operating conditions instead of worst-case operating conditions. Thus power losses can be minimized under normal operating conditions.

Because the controller 54 and the snubber transistor Qₛₙ are tied to different voltage potentials in FIG. 5, the controller 54 cannot directly drive the snubber transistor Qₛₙ. Therefore, the ADRC snubber in FIG. 5 also includes a gate driver circuit 56.

The gate driver circuit 56 can include means for isolating the different potentials of the controller 54 and the snubber transistor Qₛₙ from each other. An optocoupler U_{g} is used to form a galvanic isolation separating the different potentials of the controller 54 and the snubber transistor Qₛₙ in FIG. 5. The primary side of the optocoupler U_{g} is driven by the control signal v_{ctl}. The gate driver circuit 56 also includes a series connection of a zener diode D_{g} and a resistor R_{g,1} forming a voltage source which supplies the secondary side of the optocoupler U_{g}. The gate of the snubber transistor Qₛₙ is connected to a series connection of the optocoupler U_{g} secondary side and a resistor R_{g,2} so that the gate-source voltage v_{g} of the snubber transistor Qₛₙ can be driven responsive to the control signal v_{ctl}.

FIG. 5 illustrates only one simplified example of an implementation of the exemplary ARCD snubber topology. However, the ARCD snubber topology of the present disclosure can also be implemented in various other ways, in various other switching converter topologies. For example, other types of transistor, such as BJT, can also be used for the snubber transistor.

Performance of the ARCD snubber was demonstrated by computer simulations. The known RCD in the flyback converter of FIG. 1 and the disclosed ARCD snubber in the flyback converter of FIG. 5 were simulated. Both snubbers were designed on the basis of same design specifications and simulation parameters. The input voltage V_{S} of the flyback converter was specified to be in the range of 300 to 1200 V; the output voltage V_{O} was 24 V; the output power P_{O} was 260 W; the switching frequecy F_{S} was 60 kHz. The turns ratio Nₚ:Nₛ of the main transformer was 17:3; the magnetizing inductance Lₘ was 1 mH; the leakage inductance L_{lkg} was 20 μH. Maximum voltage stress on the main switch Q was specified to be 1500 V.

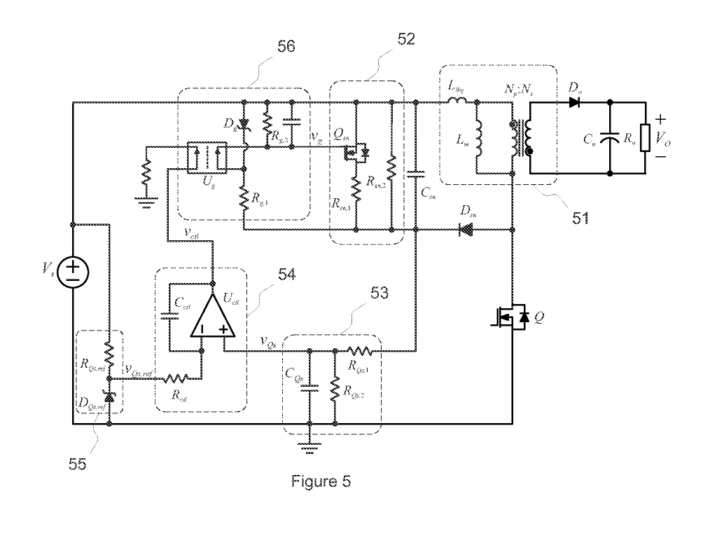

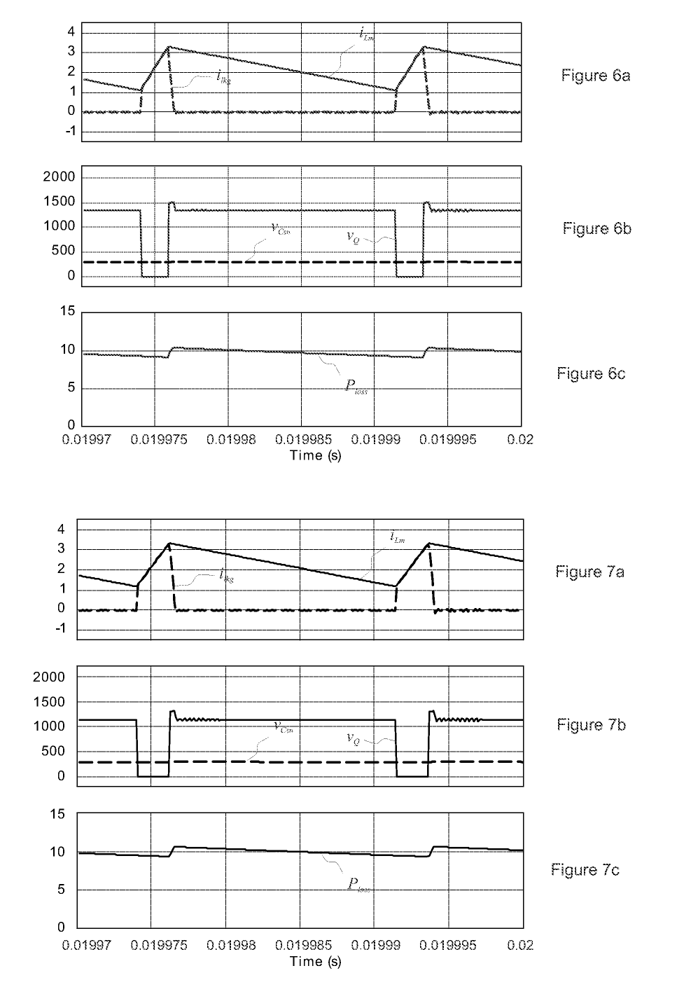

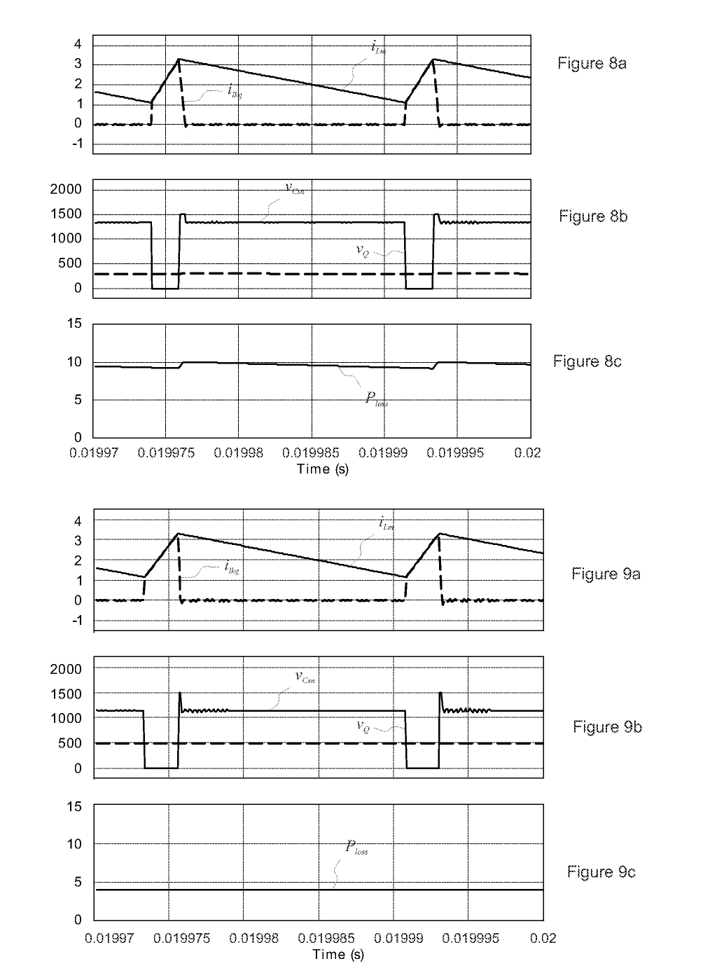

FIGS. 6a to 6c show exemplary simulated waveforms for the known RCD snubber of FIG. 1 at the input voltage V_{S} of 1200 V. FIG. 6a shows a current I_{Lm} through the magnetizing inductance Lₘ and a current I_{lkg} through the leakage inductance L_{lkg}; FIG. 6b shows a voltage v_{Q} over the switching device Q and a voltage v_{Csn} over the snubber capacitor Cₛₙ; FIG. 6c shows the snubber power loss Pₗₒₛₛ. FIGS. 7a to 7c show the same currents/voltages at the input voltage V_{S} of 1000 V. In the same manner as FIGS. 6a to 6c, FIGS. 8a to 8c show exemplary simulation waveforms for the ARCD snubber of FIG. 5 at the input voltage V_{S} of 1200 V. FIGS. 9a to 9c show the same currents/voltages for the ARCD snubber of FIG. 5 when the input voltage V_{S} was 1000 V.

Both the known RCD and the exemplary ARCD snubbers of the present disclosure were designed to guarantee a 1500—V switch voltage stress at V_{S}=1200 V. Therefore, both of the snubbers have the same power loss at this operating point, as shown in FIGS. 6c and 8c. However, the known RCD snubber still generated a large power loss even in the nominal operating conditions of V_{S}=600 V and 1000 V. In contrast, the ARCD snubber according to exemplary embodiments of the present disclosure had a snubber power loss of only about 4 W and 4.5 W at these input voltages. FIGS. 7c and 9c show the difference at 1000 V.

TABLE 1
Comparison between a known RCD and an exemplary ARCD
snubber in accordance with the present disclosure.

| | Snubber loss (W) | | Switch peak voltage (V) | |
|---|---|---|---|---|
| Input voltage (V) | RCD | ARCD | RCD | ARCD |
| 300 | 12.5 | 5.5 | 650 | 900 |
| 600 | 10.5 | 4.5 | 900 | 1120 |
| 1000 | 10 | 4 | 1300 | 1500 |
| 1200 | 9.5 | 9.5 | 1500 | 1500 |

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An adaptive RCD snubber circuit for a switching converter having a series-connection of a main inductor and a main switching device, the snubber circuit comprising:
a snubber capacitor and a snubber diode;
a controllable snubber resistance;
means for sensing a voltage stress of the main switching device; and
a snubber capacitor voltage controller configured to control the sensed voltage stress to a reference level by controlling a snubber capacitor voltage, the snubber capacitor voltage being controlled by adjusting the controllable snubber resistance.

2. The adaptive RCD snubber circuit as claimed in claim 1, wherein the controllable snubber resistance includes a transistor configured to control current through the controllable snubber resistance responsive to a control signal from the snubber capacitor voltage controller.

3. The adaptive RCD snubber circuit as claimed in claim 2, wherein the controllable snubber resistance includes a series connection of the transistor and a first snubber resistor, wherein the series connection is connected in parallel with a second snubber resistor.

4. The adaptive RCD snubber circuit as claimed in claim 1, wherein the voltage stress is represented by a sum of a voltage over the series-connection and a voltage over the snubber capacitor.

5. The adaptive RCD snubber circuit as claimed in claim 2, wherein the voltage stress is represented by a sum of a voltage over the series-connection and a voltage over the snubber capacitor.

6. The adaptive RCD snubber circuit as claimed in claim 3, wherein the voltage stress is represented by a sum of a voltage over the series-connection and a voltage over the snubber capacitor.

7. The adaptive RCD snubber circuit as claimed in claim 4, wherein the sensed voltage stress is measured as a voltage over a path formed by the main switching device and the snubber diode.

8. A switching converter, comprising the adaptive RCD snubber circuit as claimed in claim 1.

9. A method for a switching converter having a series-connection of a main inductor and a main switching device and a RCD snubber circuit, the method comprising:
sensing a voltage stress of the main switching device, and
controlling the sensed voltage stress to a reference level by controlling a snubber capacitor voltage, wherein the snubber capacitor voltage is controlled by adjusting the snubber resistance of the RCD snubber.
